(19) United States
(12) Patent Application Publication
(10) Pub. No.: US 2024/0058971 A1
(43) Pub. Date: Feb. 22, 2024

(54) ROBOTIC GRIPPER

(71) Applicant: National University of Singapore, Singapore (SG)

(72) Inventors: Jin GUO, Singapore (SG); Jin Huat LOW, Singapore (SG); Phone May KHIN, Singapore (SG); Chen Hua YEOW, Singapore (SG)

(21) Appl. No.: 18/011,107

(22) PCT Filed: Jun. 15, 2021
(86) PCT No.: PCT/SG2021/050347

§ 371 Date: Dec. 16, 2022

(30) Foreign Application Priority Data
Jun. 17, 2020 (SG) 10202005767V
Jan. 15, 2021 (SG) 10202100438Y

(51) Int. Cl. B25J 15/00; B25J 15/10; B25J 15/12

(52) U.S. Cl. CPC B25J 15/0023; B25J 15/10; B25J 15/12

(57) ABSTRACT

The present disclosure generally relates to a robotic gripper comprising: a body; a plurality of displacement mechanisms; a plurality of finger modules removably connected or connectable to the body, such that each finger module engages with a respective displacement mechanism; each finger module comprising a finger actuator cooperative with the other finger actuators for gripping an object; and each displacement mechanism is configured for moving the respective finger module to adjust its arrangement on the body, thereby configuring the robotic gripper for gripping the object.

### CROSS REFERENCE TO RELATED APPLICATIONS

The present disclosure claims the benefit of Singapore Patent Application No. 10202005767V filed on 17 Jun. 2020 and Singapore Patent Application No. 10202100438Y filed on 15 Jan. 2021, each of which is incorporated in its entirety by reference herein.

### TECHNICAL FIELD

The present disclosure generally relates to a robotic gripper. More particularly, the present disclosure describes various embodiments of the robotic gripper as well as finger actuators of the robotic gripper.

### BACKGROUND

The field of robotics has been advancing to address the growing demand for greater efficiency and productivity in many manufacturing industries. Many companies produce robotic grippers that are used for various purposes in manufacturing and automation. For example, in food manufacturing, traditional rigid grippers and vacuum packaging systems are used for food picking and packaging for automation process. However, traditional grippers have difficulties to perform such tasks well because the rigidity of grippers may damage the delicate food items without proper force control and the vacuum packaging system can only lift items with clean flat smooth surfaces. There are thus limitations to the applications of such rigid grippers and vacuum systems in the food sector, particularly since food items come in diverse range of shapes, sizes, textures, and orientations (such as on a conveyor belt for picking) which makes it challenging for conventional grippers to manipulate these items.

Soft robotic grippers have been developed for the food sector to cope with the high variability of delicate food items during the automation process. These soft robotic grippers, such as elastomeric actuators and fabric-based actuators, can deform and morph according to the external reaction forces, enabling them to be used for a diverse range of fragile items. However, the softness of the actuators limits the dexterity and gripping performance, especially during pick-and-place tasks in a tightly cluttered environment. The low dexterity of the gripper's gripping configuration also limits the applicability of these grippers to complex handling processes, especially in food handling processes which require more intricate planning of gripping configurations and directions with respect to the location and physical form of food items.

Therefore, in order to address or alleviate at least one of the aforementioned problems and/or disadvantages, there is a need to provide an improved robotic gripper.

### SUMMARY

According to a first aspect of the present disclosure, there is a robotic gripper comprising: a body; a plurality of displacement mechanisms; a plurality of finger modules removably connected or connectable to the body, such that each finger module engages with a respective displacement mechanism; each finger module comprising a finger actuator cooperative with the other finger actuators for gripping an object; and each displacement mechanism is configured for moving the respective finger module to adjust its arrangement on the body, thereby configuring the robotic gripper for gripping the object.

According to a second aspect of the present disclosure, there is a method for configuring a robotic gripper, the method comprising: operating the robotic gripper comprising a plurality of finger modules and a plurality of displacement mechanisms, the finger modules removably connected to a body of the robotic gripper; engaging each finger module with a respective displacement mechanism; arranging the finger modules for gripping an object, each finger module comprising a finger actuator cooperative with the other finger actuators for gripping the object; and moving, using the respective displacement mechanisms, one or more finger modules to adjust their arrangement on the body, thereby configuring the robotic gripper for gripping the object.

According to a third aspect of the present disclosure, there is a method for handling objects with a robotic gripper, the method comprising: capturing visual data of the objects arranged at a first location using an imaging device, the visual data comprising colour image data and point cloud data; detecting the objects based on the colour image data and a trained image classifier; selecting one or more detected objects based on the point cloud data to be handled by the robotic gripper; determining, for each selected object, a grip configuration for the robotic gripper to handle the selected object; computing trajectories for the robotic gripper to move between the first location and a second location; transferring, using the robotic gripper and the respective grip configurations, the selected objects along the computed trajectories from the first location to the second location, wherein the selection of objects and transferring of objects are processed concurrently in a multithreaded computer process.

According to a fourth aspect of the present disclosure, there is a finger actuator comprising: a resilient element for stiffening the finger actuator; and a cover plate and an inflatable channel arranged at a proximal section of the finger actuator, the resilient element disposed between the cover plate and inflatable channel, wherein upon inflation of the channel, the inflated channel presses the resilient element against the cover plate, thereby stiffening the finger actuator; and wherein upon actuation and bending of the finger actuator, the resilient element moves towards a distal section of the finger actuator, the inflated channel preventing returning of the resilient element, thereby locking the bent finger actuator.

According to a fifth aspect of the present disclosure, there is a method for locking a bending profile of a finger actuator, the method comprising: inflating a proximal portion of a fluidic channel of the finger actuator, the proximal fluidic channel portion arranged at a proximal section of the finger actuator; upon inflation of the proximal fluidic channel portion, pressing a resilient element against a cover plate arranged at the proximal section, the resilient element disposed between the cover plate and the proximal fluidic channel portion; stiffening the finger actuator upon said pressing of the resilient element against the cover plate; inflating a distal portion of the fluidic channel to actuate the finger actuator, the distal fluidic channel portion arranged at a distal section of the finger actuator; upon actuation of the finger actuator, bending the finger actuator and moving the resilient element towards the distal section, wherein the inflated proximal fluidic channel portion prevents returning of the resilient element, thereby locking the bent finger actuator.

A robotic gripper according to the present disclosure are thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIGS. 1A to 1C illustrate a robotic gripper according to embodiments of the present disclosure.

FIGS. 2A to 2C illustrate the robotic gripper in various grip configurations.

FIGS. 3A to 3C illustrate a finger actuator of the robotic gripper.

FIGS. 4A and 4B illustrate a test performed on the finger actuator.

FIG. 5 illustrates a tactile sensor of the robotic gripper.

FIGS. 6A to 6C illustrate results of tests performed on the tactile sensor.

FIGS. 7A to 7C illustrate results of tests performed on finger modules and tactile sensors of the robotic gripper.

FIGS. 8A to 8G illustrate the robotic gripper handling food items.

FIGS. 9A and 9B illustrate the robotic gripper cooperative with a vision system.

FIG. 10 illustrates a method for handling objects with the robotic gripper.

FIG. 11 illustrates a method for adjusting the robotic gripper.

FIGS. 12A and 12B illustrate a rotatable joint mechanism coupled with the robotic gripper.

FIGS. 13A to 13C illustrate a finger actuator having a resilient element.

FIG. 14 illustrates a method for locking the bending profile of the finger actuator having the resilient element.

FIG. 15 illustrates results of tests performed on the robotic gripper and conventional grippers.

### DETAILED DESCRIPTION

For purposes of brevity and clarity, descriptions of embodiments of the present disclosure are directed to a robotic gripper, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

In embodiments of the present disclosure, depiction of a given element or consideration or use of a particular element number in a particular figure or a reference thereto in corresponding descriptive material can encompass the same, an equivalent, or an analogous element or element number identified in another figure or descriptive material associated therewith.

References to “an embodiment/example”, “another embodiment/example”, “some embodiments/examples”, “some other embodiments/examples”, and so on, indicate that the embodiment(s)/example(s) so described may include a particular feature, structure, characteristic, property, element, or limitation, but that not every embodiment/example necessarily includes that particular feature, structure, characteristic, property, element or limitation. Furthermore, repeated use of the phrase “in an embodiment/example” or “in another embodiment/example” does not necessarily refer to the same embodiment/example.

The terms “comprising”, “including”, “having”, and the like do not exclude the presence of other features/elements/steps than those listed in an embodiment. Recitation of certain features/elements/steps in mutually different embodiments does not indicate that a combination of these features/elements/steps cannot be used in an embodiment.

As used herein, the terms “a” and “an” are defined as one or more than one. The use of “/” in a figure or associated text is understood to mean “and/or” unless otherwise indicated. The term “set” is defined as a non-empty finite organization of elements that mathematically exhibits a cardinality of at least one (e.g. a set as defined herein can correspond to a unit, singlet, or single-element set, or a multiple-element set), in accordance with known mathematical definitions. The recitation of a particular numerical value or value range herein is understood to include or be a recitation of an approximate numerical value or value range.

Robotic Gripper

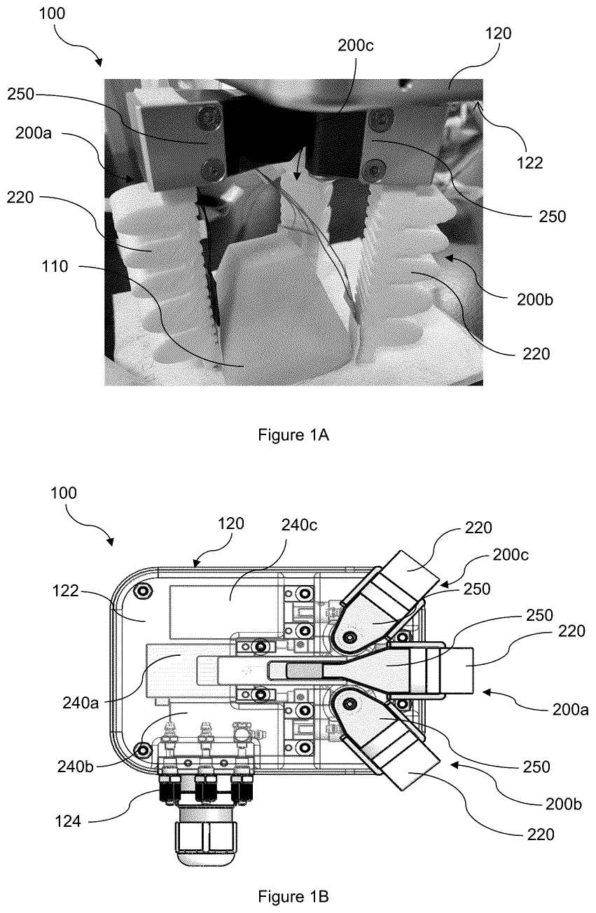

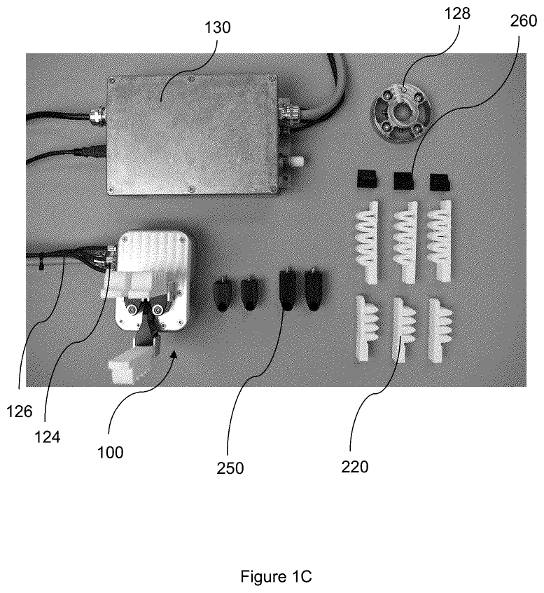

In representative or exemplary embodiments of the present disclosure, there is a robotic gripper 100 as shown in FIGS. 1A to 1C. The robotic gripper 100 can be used to grip or grasp objects 110, such as food items, for various processes such as automated pick-and-place tasks. The robotic gripper 100 includes a body 120 and a plurality of finger modules 200 removably connected or connectable to the body 120. Each finger module 200 has a finger actuator 220 cooperative with the other finger actuators 220 for gripping the object 110. The robotic gripper 100 includes a plurality of displacement mechanisms 240 such that when the finger modules 200 are connected to the body 120, each finger module 200 engages with a respective one of the displacement mechanisms 240. As an example, the body 120 has a base 122 and the finger modules 200 are connected to the base 122 and engaged with the displacement mechanisms 240 via the base 122. The finger modules 200 are removably connected to the body 120 such that the finger modules 200 can be easily removed by a user of the robotic gripper 100 without causing significant damage to the finger modules 200, displacement mechanisms 240, and/or other parts of the robotic gripper 100.

Each displacement mechanism 240 is engageable with a respective one of the finger modules 200 and is configured for moving the respective finger module 200 to adjust its arrangement on the body 120. For example, a displacement mechanism 240 is configured for linear and/or rotational displacement of the respective finger module 200 with respect to the body 120. The arrangement of the finger modules 200 on the body 120 can thus be adjusted by the displacement mechanisms 240 to thereby configure the robotic gripper 100 for gripping the object 110. For example, the arrangement can be adjusted such that the finger modules 200 are wider apart for gripping a larger object 110.

The robotic gripper 100 can thus be repeatedly reconfigured for gripping of a diverse range of objects 110 in various shapes, sizes, textures, and orientations. The dimensions of the body 120 are about 78 mm×105 mm×39 mm, and the robotic gripper 100 weighs about 760 g. The compact size of the robotic gripper 100 makes it suitable for handling of small objects 110, especially for picking and placing small food items in a fast-moving and tightly cluttered environment.

In many embodiments such as shown in FIGS. 1A and 1B, the robotic gripper 100 includes three finger modules 200 with three finger actuators 220. A first finger module 200a may resemble a centre finger or thumb. A second finger module 200b and a third finger module 200c may resemble two other fingers that are moveable about the base 122 with respect to the thumb.

The first finger module 200a may be fixed in position or its position can be adjusted by a first displacement mechanism 240a. The first displacement mechanism 240a may include a linear actuator or linear stepper motor for linear displacement of the first finger module 200a. The linear displacement may be up to 20 mm in both directions. Similarly, each of the second finger module 200b and third finger module 200c may be fixed in position or their positions can be adjusted by a second displacement mechanism 240b and third displacement mechanism 240c, respectively. The second and third displacement mechanisms 240bc may include stepper motors for rotational displacement of the second and third finger modules 200bc, respectively. The rotational displacement may span up to 150°. It will be appreciated that any of the displacement mechanisms 240 may include suitable actuators and/or motors for linear and/or rotational displacement of the finger modules 200.

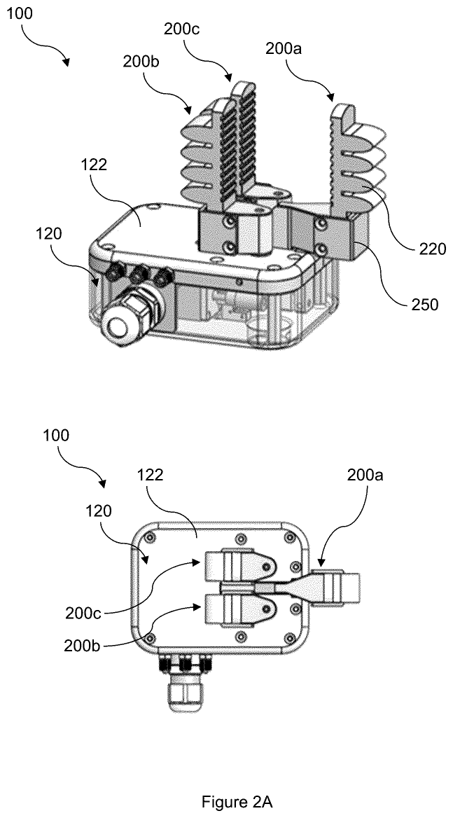

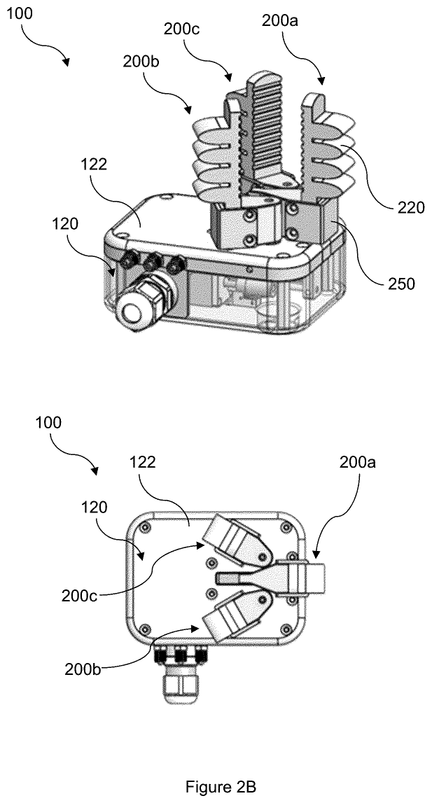

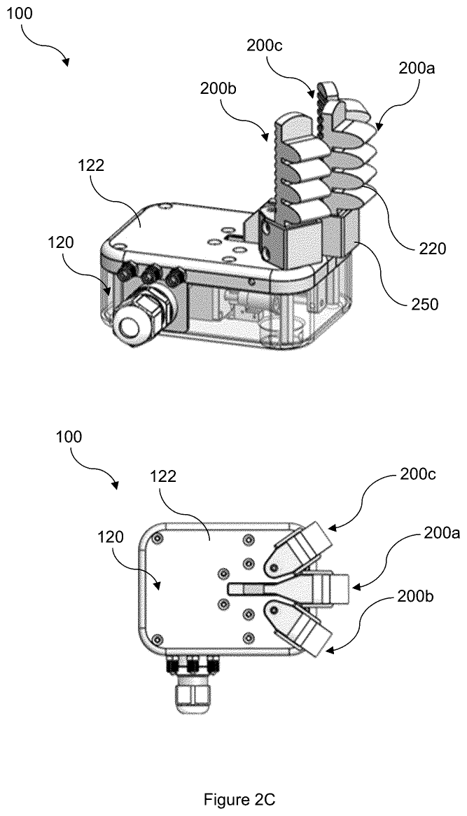

Adjustability of the arrangement of the finger modules 200 allows the robotic gripper 100 to manipulate a greater variety of objects 110. As shown in FIGS. 2A to 2C, the robotic gripper 100 can be configured to variable gripping modes to handle different objects 110 in a more efficient way. As shown in FIG. 2A, the robotic gripper 100 is configured for pinching and the finger modules 200 are arranged in a pinch arrangement. In the pinch arrangement, the first to third finger modules 200a-c are arranged substantially in parallel to each other, i.e. the second and third finger modules 200bc are 0° relative to the first finger module 200a. As shown in FIG. 2B, the robotic gripper 100 is configured for clawing and the finger modules 200 are arranged in a claw arrangement. In the claw arrangement, the second and third finger modules 200bc are rotated by 30° relative to the pinch arrangement. The first finger module 200a may be moved by up to the maximum linear displacement (e.g. 20 mm) relative to the pinch arrangement. As shown in FIG. 2C, the robotic gripper 100 is configured for scooping and the finger modules 200 are arranged in a scoop arrangement. In the scoop arrangement, the second and third finger modules 200bc are rotated to the maximum angle (e.g. 150°) relative to the pinch arrangement and are placed closest to the first finger module 200a. The first finger module 200a may be moved by up to the maximum linear displacement (e.g. 20 mm) relative to the pinch arrangement.

The finger modules 200 are removably connected to the body 120 such that they can be easily detached and replaced with other finger modules 200 of various designs to accommodate a wider range of gripping configurations. Different combinations of finger modules 200 may achieve a range of gripping widths, such as from 30 mm to 70 mm, in order to cope with objects 110 of different shapes and sizes. Each finger module 200 may further include a finger connector 250 that is removably connected to the respective displacement mechanism 240 and the finger actuator 220 is in turn removably connected to the finger connector 250. The finger connector 250 can facilitate changing of the finger actuator 220 without changing the whole finger module 200.

In many embodiments, each finger actuator 220 is inflatable or includes an inflatable actuator so that upon inflation, the finger actuators 220 are cooperative with each other for gripping the object 110. For example, the body 120 is configured for communication of fluids, e.g. air, to inflate and deflate the finger actuators 220, thereby controlling actuation of the finger actuators 220 to grip the object 110. As shown in FIG. 1C, the body 120 may be connected to a pneumatic source, such as an air compressor, via fluidic connectors 124 and pneumatic lines 126. The air compressor supplies compressed air to the finger actuators 220 and the fluidic connectors 124 may include or may be connected to pneumatic solenoid valves configured to control the inflation and deflation of the finger actuators 220 by turning on and off, respectively. A pneumatic pressure sensor may be connected to the finger actuator 220 to measure the pneumatic pressure upon inflation of the finger actuator 220. Gripping and releasing of the object 110 can thus be controlled by triggering the solenoid valve accordingly. The air compressor may deliver compressed air at a maximum flow rate of 35 to 40 L/min and may supply a pneumatic pressure of up to 600 kPa.

The robotic gripper 100 may be connected to a separate robot or robotic arm via a mounting connector 128. The robotic gripper 100 may include a control module 130 for controlling actuation of the finger actuators 220 to grip the object 110. For example, the control module 130 is configured for controlling the solenoid valve to inflate and deflate the finger actuators 220. Additionally, the control module 130 is configured for controlling the displacement mechanisms 240 to move the finger modules 200 on the body 120 and adjust the arrangement of the finger modules 200. For example, the control module 130 can provide the user with precise control of the degrees of rotation and/or distance of linear motion of the finger modules 200. The control module 130 may further provide predefined grip configurations for selection by the user, such as by a software user interface communicative with the control module 130.

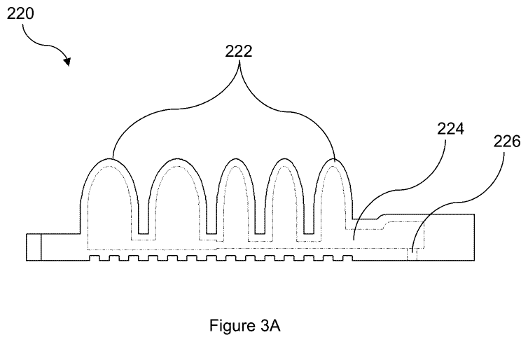

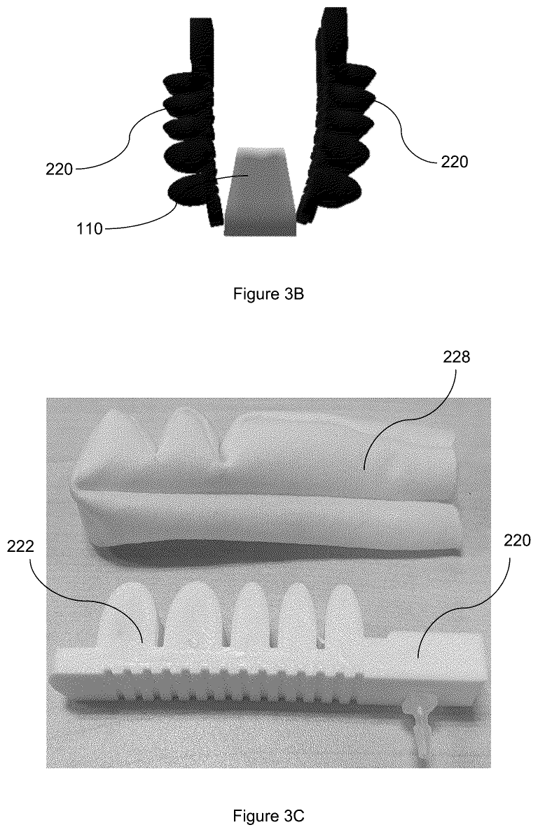

An example of the finger actuator 220 is shown in FIG. 3A. The finger actuator 220 may be formed by additive manufacturing or 3D printing using various suitable materials. For example, the finger actuator 220 is made of a thermoplastic elastomer material such as NinjaFlex filament. Many existing soft grippers have an elastomeric material such as Ecoflex™ 00-30 which has a Young's modulus of about 0.125 MPa. The NinjaFlex filament material has a higher Young's modulus of about 12 MPa, and this increase in stiffness enhances the rigidity of the finger actuator 220 while still maintaining the softness property of the material. This balance of stiffness and softness properties allows the finger actuators 220 to gently grip delicate objects 110 (such as uncooked tofu) and yet still achieve better gripping stability, enabling the robotic gripper 100 to perform pick and place tasks of the objects 110 under fast-moving conditions.

As shown in FIG. 3A, the finger actuator 220 has a series of bellow-shaped sections 222, a fluidic channel 224, and a fluidic inlet 226. The fluidic channel 224 and fluidic inlet 226 are fluidically connected to the pneumatic source via the solenoid valve for inflation and deflation of the bellow-shaped sections 222. The internal fluidic channel 224 allows the finger module 200 to be replaced easily without changing the air connection.

The finger actuator 220 has a number of (e.g. three) smaller-width bellow-shaped sections 222 at the proximal portion and a number of (e.g. two) larger-width bellow-shaped sections 222 at the distal portion. A simulation of the finger actuators 220 gripping an object 110 (a potato) is shown in FIG. 3B. This configuration of bellow-shaped sections 222 reduces over-bending and generates a larger grip force (about 200 kPa). This improves the gripping performance while maintaining dexterity and delicacy of the grip, allowing the finger actuators 220 to be used for gripping objects 110 like small delicate food items.

As shown in FIG. 3C, the finger module 200 may include a sleeve 228 for wearing over the finger actuator 220, specifically the bellow-shaped sections 222, to achieve benefits such as food safety and fire safety. The sleeve 228 may be made of a soft material such as silicone, fabric, etc. For example, the sleeve 228 is made of a food safe or food grade material for food safety so that the finger actuator 220 can be used to safely grip food items without contaminating them. One such material is a food-safe waterproof polyurethane laminated fabric that has been certified under the United States Consumer Product Safety Improvement Act (CPSIA). The sleeve 228 is customized to the finger actuator 220, particularly to the profile of the bellow-shaped sections 222, and may include groove-patterned or conformable surfaces to improve the gripping performance of the finger actuator 220. The gripping surfaces of the bellow-shaped sections 222 may include groove and/or anti-slip patterns to improve gripping performance. Suitable materials may be formed on the gripping surfaces of the sleeve 228 to provide various functionalities, such as high friction materials with anti-slip properties to minimize slippage.

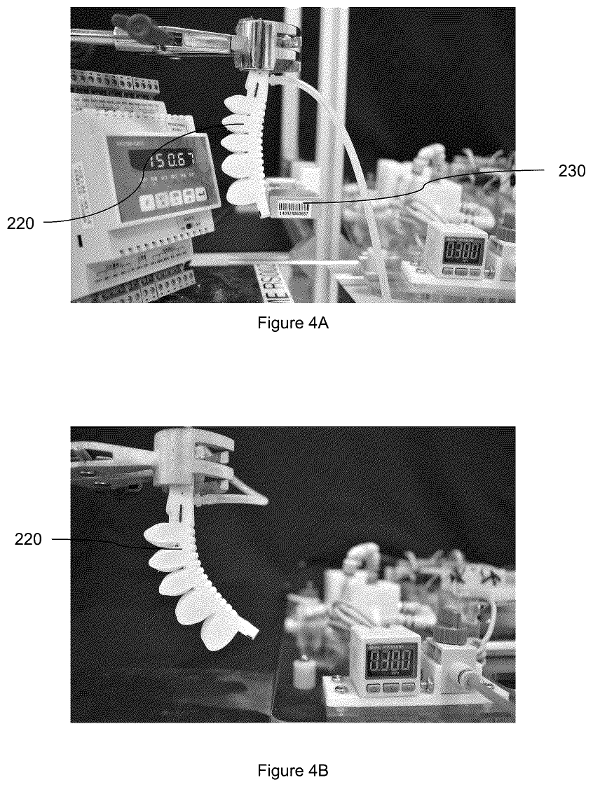

With reference to FIGS. 4A and 4B, an experiment was performed to investigate various parameters of the finger actuator 220, including bending force, bending profile, and durability. The bending force and bending profile parameters were investigated by applying pneumatic pressure from 0 kPa to 300 kPa in 25 kPa incremental steps. Three finger actuators 220 were used in the experiment and the resultant data was averaged for each parameter at each pneumatic pressure.

The bending force was measured directly by a load cell 230. The average bending force generated by the finger actuator 220 without the food-safe sleeve 228 and at 300 kPa pneumatic pressure was 2.36±0.1 N. The average bending force generated by the finger actuator 220 with the food-safe sleeve 228 and at 300 kPa pneumatic pressure was 2.6±0.02 N. The bending angle (θ) of the inflated finger actuator 220 was measured, using an image analysis software, by the angle between the vertical axis and a tangential line through the distal section of the finger actuator 220. The average bending angle of the finger actuator 220 without the food-safe sleeve 228 and at 300 kPa pneumatic pressure was 56.15±0.97°. The average bending angle of the finger actuator 220 with the food-safe sleeve 228 and at 300 kPa pneumatic pressure was 46.07±1.91°. The sleeve 228 helped to restrain the bending profile of the finger actuator 220 so that the finger actuator 220 does not over bend under higher pneumatic pressure. The higher pneumatic pressure would be used to generate a stronger grip force instead of bending the finger actuator 220, thus achieving a better gripping performance.

In the durability test, the finger actuator 220 was tested up to 25,000 cycles of gripping under 300 kPa pneumatic pressure. In each cycle, the solenoid valve was turned on for seconds to inflate the finger actuator 220 to 300 kPa pneumatic pressure and the solenoid valve was subsequently turned off for 5 seconds to deflate the finger actuator 220. The durability test showed no significant changes in the bending force and bending profile parameters of the finger actuator 220 after 25,000 cycles. This shows that the finger actuator 220 is durable enough to last for at least 25,000 pick-and-place tasks. For example, the robotic gripper 100 can be used for preparing in-flight meals. An in-flight meal typically has five food items and requires around 15 seconds to prepare (around 3 seconds per food item). The robotic gripper 100 can prepare at least 5,000 in-flight meals within a day and more efficiently without compromising its performance.

In some embodiments as shown in FIG. 1C, the finger module 200 further includes a finger ender 260 removably attachable to the distal section of the finger actuator 220. The finger ender 260 may include one or more sensors for measurement of data associated with the gripping of the object 110. These sensors may include, but are not limited to, temperature sensor, force sensor, pressure sensor, and tactile sensor.

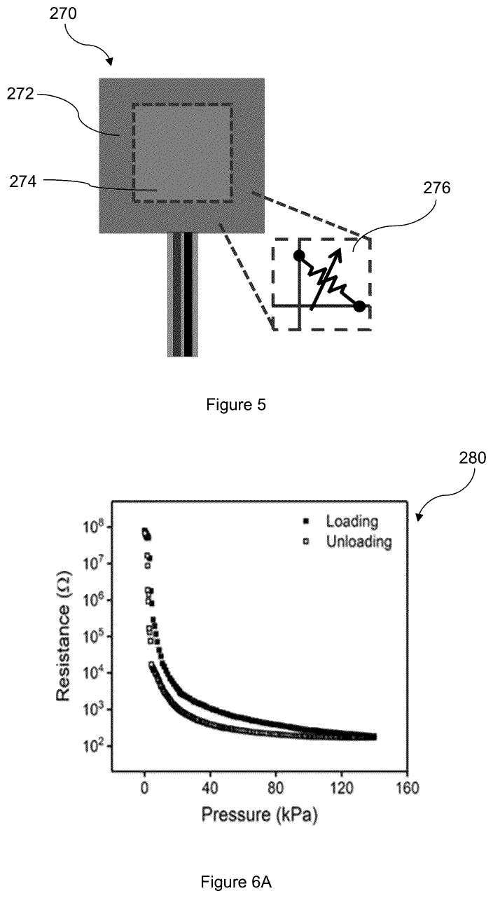

Tactile Sensor In one embodiment as shown in FIG. 1A, each finger module 200 includes a tactile sensor 270. A tactile sensor is data acquisition device designed to sense various properties via direct physical contact. The tactile sensor 270 may be disposed directly on the distal section of the finger actuator 220 or on a finger ender 260 attached to the finger actuator 220. Further as shown in FIG. 5, the tactile sensor 270 includes a substrate 272 and a sensing taxel 274 disposed on the substrate 272. The sensing taxel 274 may include one or more piezoresistive, conductive rubber, and metallic capacitive sensing elements 276.

An experiment was performed on the tactile sensor 270 having a piezoresistive sensing element 276 to evaluate its performance. The tactile sensor 270 was first calibrated using a motorized z-axis stage assembled with a force gauge. A force of 5 N (corresponding to a pressure of 140 kPa) was applied on the sensor at a loading rate of 5 μm/s, and meanwhile the resistance of the tactile sensor 270 was recorded by a source meter. Reliability of the tactile sensor 270 during cyclic loading was evaluated by applying the same force at a higher loading rate (500 μm/s). A time interval of around 5 seconds was set between two cycles to simulate the gripping cycles during pick-and-place tasks. Response time of the tactile sensor 270 was also evaluated by applying a small load using Blu-Tack, which corresponds to the pressure of about 100 Pa. The response time was defined as the fall time of resistance change during unloading.

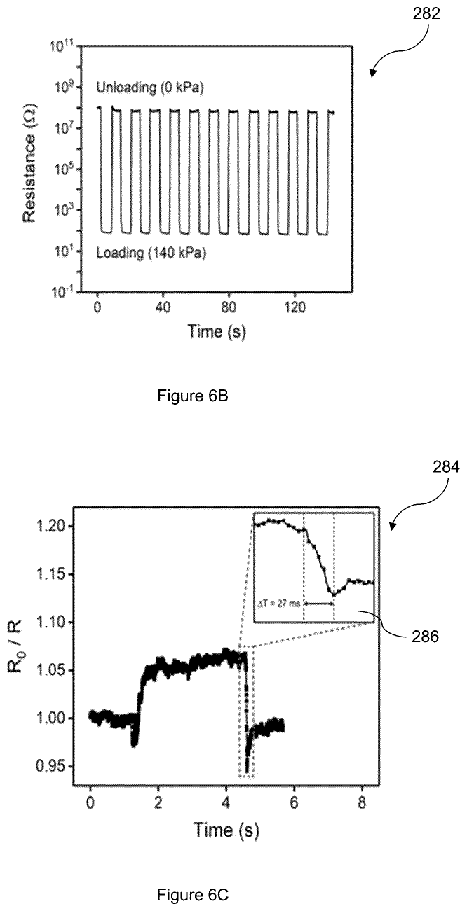

Results of the experiment are shown in FIGS. 6A to 6C. FIG. 6A shows the results 280 of resistance change of the tactile sensor 270 resulting from loading to 140 kPa. When the pressure increased from 0 to 140 kPa, the resistance of the tactile sensor 270 decreased from 108Ω to 102Ω. The tactile sensor 270 exhibits a large resistance change over a wide pressure range. There is a hysteresis effect between the loading and unloading curve, which is due to the hyper elasticity of the PDMS and PEDOT:PSS polymers. However, this hysteresis effect does not affect the reliability of the tactile sensor 270 during cyclic loading. FIG. 6B shows the results 282 of resistance change during the cyclic loading of 140 kPa for 12 cycles. When the same load was repeatably applied, the tactile sensor 270 produced similar resistance change as shown in FIG. 6B, thus showing reliable and stable sensor performance. FIG. 6C shows the results 284 of the response time of the tactile sensor 270 during loading and unloading. The tactile sensor 270 responded to pressure by changing the resistance and there was a rise time and fall time when the pressure was loaded and unloaded, respectively. To reduce or eliminate the effect of loading rate, the fall time is defined as the sensor response time. As shown in inset 286, the tactile sensor 270 can respond to pressure within 27 ms. The experiment results show that the tactile sensor 270 can reliably sense gentle touch of about 100 Pa and remain functional even at high pressures of 140 kPa. The tactile sensor 270 has a wide sensitivity range and is able to sense contact force on both fragile objects 110 (such as pudding) and rigid objects 110 (such as tangerine).

Flexible tactile sensors 270 with high sensitivities, a wide pressure range, and reliable performances allow the robotic gripper 100 to achieve haptic feedback and measurement of contact force. The microstructure design significantly improves the sensitivity at a low-pressure range and enables the tactile sensor 270 to sense small pressure changes. The tactile sensor 270 is also responsive to pressure over a wide pressure range from 100 Pa to 140 kPa. Moreover, the microstructure design relatively reduces the hysteresis effect and improvers sensor reliability over cycles.

Feedback System

A closed-loop feedback control system can be developed for the tactile sensor 270 given the wide range of sensitivity and smooth pressure response. The feedback control system is useful in controlling the grip configuration in food packing environments since food items come in different shapes, sizes, and orientations. The optimal grip configuration for each food item would depend on the physical characteristics of the food item, as well as its layout and surrounding environment.

A grip configuration exploration experiment was performed to evaluate various grip configurations, and particularly to investigate how contact force varied with respect to changes in grip configuration. The robotic gripper 100 was sensorized by incorporating the tactile sensors 270 at each of the three finger modules 200. Three grip configurations were used to grip the given food item 110 (an irregularly shaped potato) as shown in FIG. 1A. The first finger module 200a remained in the same position in all three grip configurations. In the first grip configuration, the second and third finger modules 200bc were rotated to 0°. In the second grip configuration, the second and third finger modules 200bc were rotated to 30°. In the third grip configuration, the second and third finger modules 200bc were rotated to 45°.

During the experiment, the finger modules 200 reoriented into each grip configuration and held the food item 110 for 5 seconds and released it. The food item 110 was gripped but not lifted. The robotic gripper 100 repeated this procedure for all three grip configurations. A force sensor measured the force readings at 50 Hz and the stability of each grip configuration was analyzed.

In this analysis, a covariance matrix of force readings over a period (m) was constructed recursively. The matrix observed the relative changes in force sensor readings of the three finger modules 200 over time. From the matrix, covariance (cov) of force readings in one finger module 200 with respect to the other finger modules 200 (cov(1,2), cov(1,3), cov(2,3)) and variance (var) of force readings in one module 200 with respect to itself (var(1,1), var(2,2) and var(3,3)) were derived. In this notation, “1” refers to first finger module 200a, “2” refers to second finger module 200b, and “3” refers to third finger module 200c. Tracing the magnitude and direction of relative changes in contact force allowed for better understand how the food item 110 is gripped by the finger modules 200.

The sensor recordings at time step (tₖ) are denoted as:

\vec{f}(tₖ)=[f₁(tₖ),f₂(tₖ), . . . ,fₙ(tₖ)],

where n=3 due to the presence of three finger modules 200 and hence three tactile sensors 270 in the robotic gripper 100.

The force readings for a period (m) time are stored in the matrix F(tₖ) as:

F(tₖ)=[\vec{f}(tₖ),\vec{f}(tₖ₋₁), . . . ,\vec{f}(tₖ₋ₘ)].

Subsequently, the covariance matrix for sensor reading at time step (tₖ) is formulated as:

K_{FF}=E[(F−μ_{F})(F−μ_{F})_{T}],

where μ_{F}=E[F].

During a stable grip, the force applied by each of the finger modules 200 was assumed to be steady. Hence, the covariance matrix (K_{FF}) would be a n×n diagonal matrix whereby the diagonals will be either constants or zero. Moving forward, the grip initiation phase would be referred to the transition phase where the finger modules 200 begin to flex until it reaches a predetermined pressure threshold. The gripping phase would be referred to the phase whereby the finger modules 200 are maintained at the predetermined pressure threshold to hold on to the food item 110.

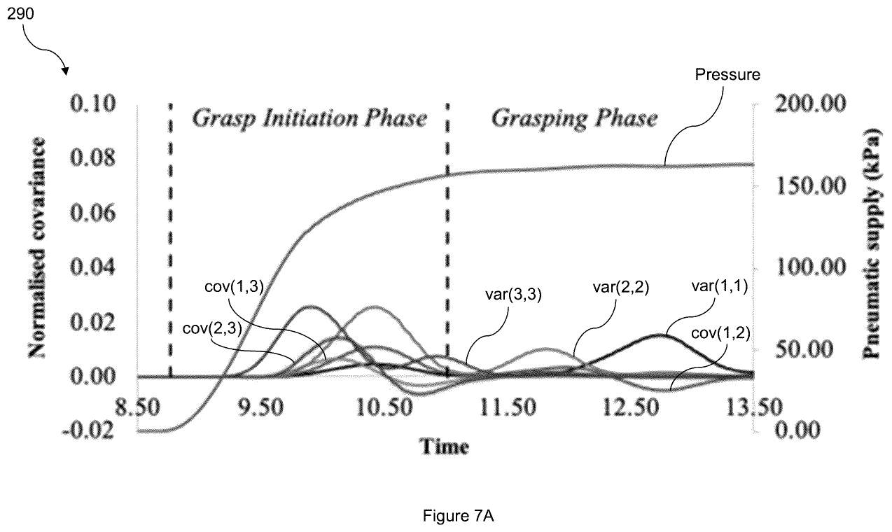

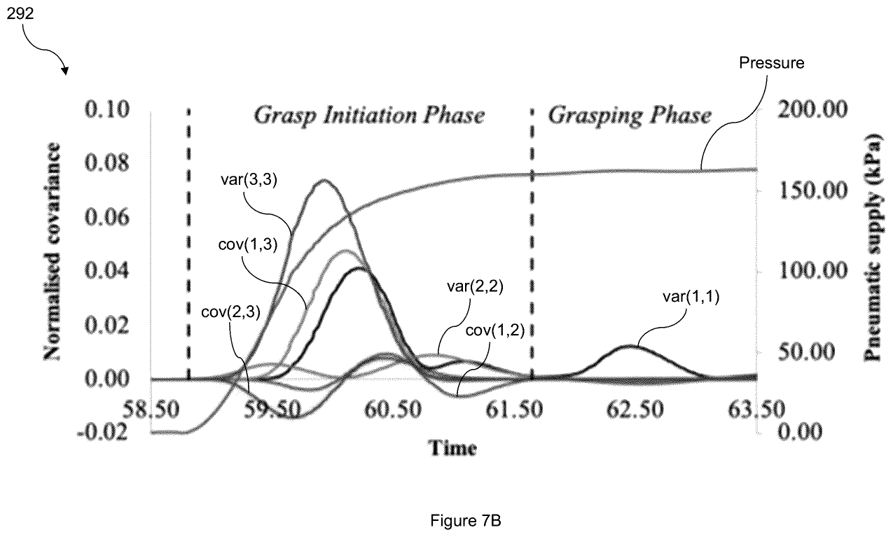

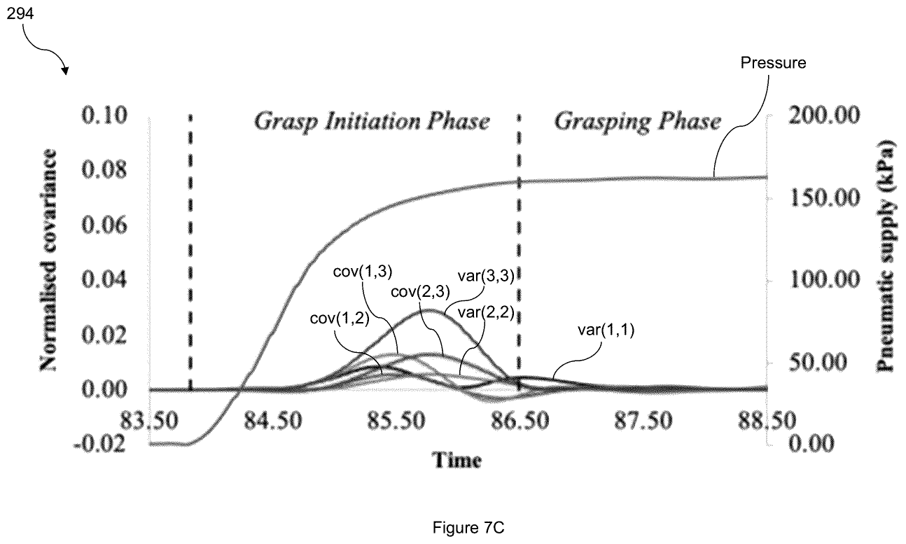

FIGS. 7A to 7C show the changes in variance and covariance between different pairs of finger modules 200 and corresponding tactile sensors 270. As shown in graph 290 in FIG. 7A for the first grip configuration, the covariance trends (cov(1,2), cov(1,3), cov(2,3)) displayed asynchronous fluctuations. Similarly, as shown in graph 292 in FIG. 7B for the second grip configuration, the covariance trends (cov(1,2), cov(1,3), cov(2,3)) also displayed asynchronous fluctuations. These fluctuations were caused by instability in the location of the food item 110 during the grip initiation phase when it shifted back and forth between the finger modules 200, resulting in fluctuation of contact forces. Moreover, during the gripping phase, inconsistent variance and covariance trends were still observed when the first and second grip configurations were used. However, when the third grip configuration was used, as shown in graph 294 in FIG. 7C, the covariance spikes were significantly reduced which indicated that the finger modules 200 were able to maintain a more stable grip on the food item 110. Hence, the third grip configuration would be the optimal grip configuration for gripping the irregular shaped potato.

The closed-loop feedback control system was thus constructed based on the grip configuration exploration experiment. The feedback system enabled the robotic gripper 100 to search for a stable grip configuration before picking up the object 110. The robotic gripper 100 would attempt to hold the object 110 for 1 second using different grip configurations. Corresponding force readings were recorded and ranked using a grip configuration comparator developed from the experiment. The comparator ranked the stability of grip configurations based on intensity of fluctuations in variance and covariance trends. Based on the ranking, the most stable grip configuration, which would have the least occurrence of covariance spikes during the grip initiation phase, was selected to pick up the object 110.

The feedback system was validated by tasking the robotic gripper 100 to pick up the irregularly shaped potato. Specifically, the potato was arranged in five random orientations and the robotic gripper 100 was tasked to pick up the potato three times at each orientation. This was performed twice whereby the robotic gripper 100 was supplied with 150 kPa and 175 kPa pressure at each time. It was observed that the consistency in selection of stable grip configuration by the comparator was 73.33% when 150 kPa pressure was supplied. The consistency increased to 93.33% when 175 kPa pressure was supplied. The success rate of the feedback system was determined based on whether the robotic gripper 100 was able to successfully pick up the potato using the selected grip configuration. The success rate was observed to be 93.33% and 100% for 150 kPa and 175 kPa pressure, respectively. Due to inconsistent surface structure of the potato, the contact force profile would vary if there were slight variations in how the potato was oriented at the beginning of each task. The difference became more significant at lower pressure as the finger modules 200 were not able to grip the potato firmly. This also increased the risk of dropping the potato when picking it up. Hence, lower selection consistency and success rate were observed when 150 kPa pressure was supplied. On the other hand, 175 kPa pressure proved to be sufficient to successfully pick up the potato. Hence, by identifying the best grip configuration to ensure successful gripping through the tactile sensors 270, the robotic gripper 100 is able to readjust its individual finger modules 200 to successful grip the object 110.

Robotic Arms

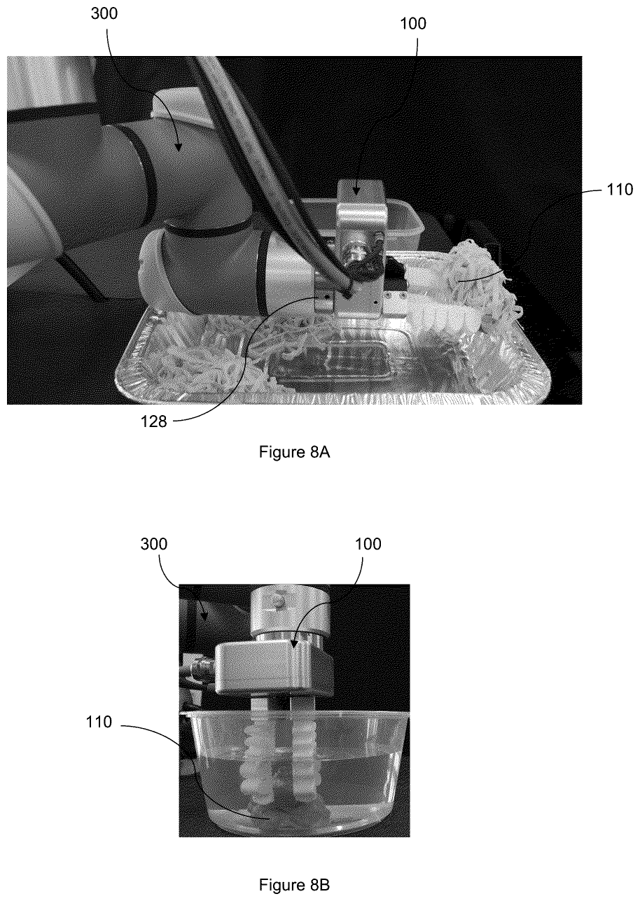

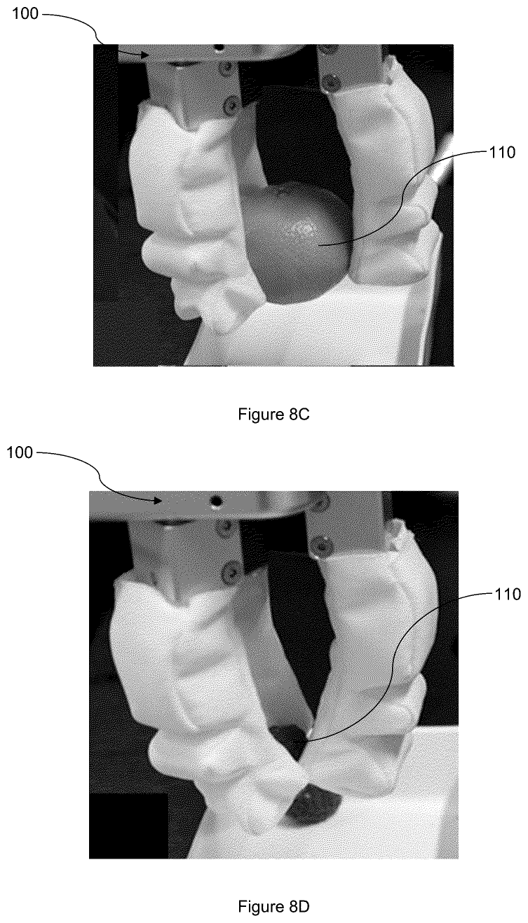

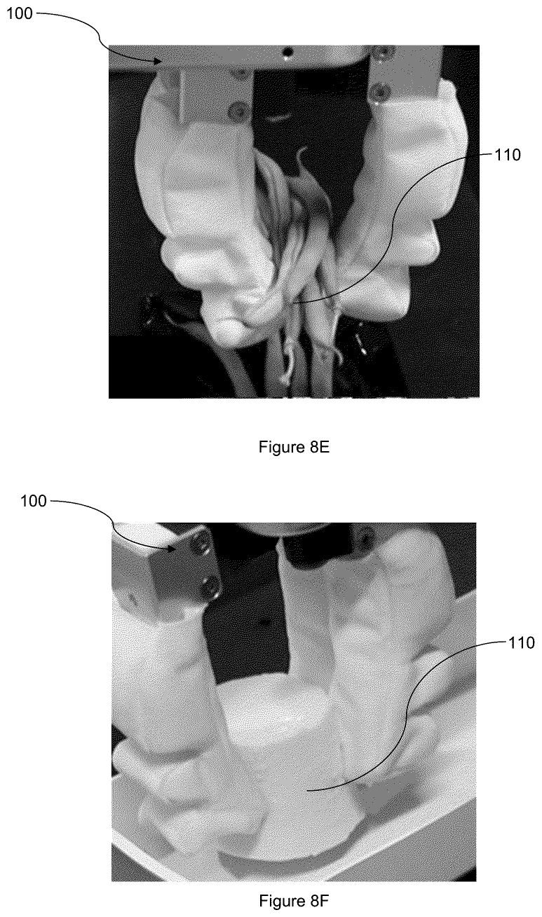

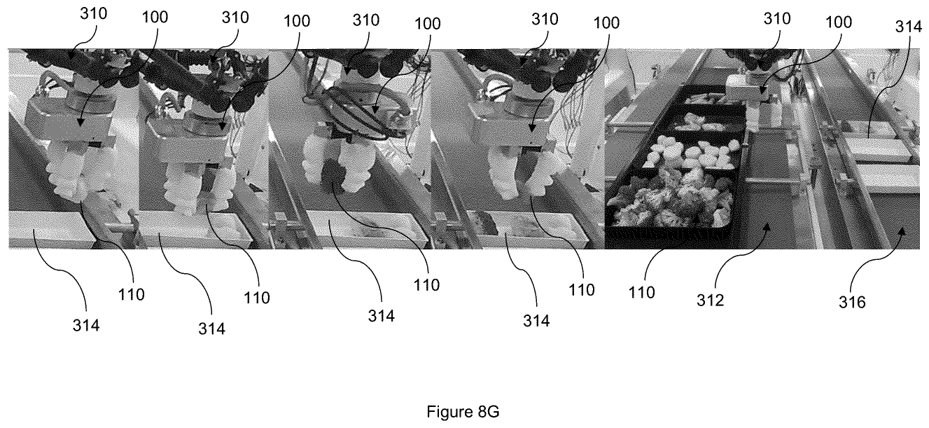

The robotic gripper 100 can be attached to a robotic arm 300 via the mounting connector 128, such as the UR5e collaborative robotic arm, for performing various gripping tasks and manipulate objects 110 with various grip configurations, particularly food items 110 in food processing and packaging. Different gripping configurations were adopted based on the shape and size of the food items 110. FIGS. 8A to 8G show the gripping tasks performed by the robotic gripper 100 attached to the robotic arm 300. The finger modules 200 were 15 mm wide and had corresponding width ranges from 30 mm to 50 mm.

As shown in FIG. 8A, the robotic gripper 100 adopted a grip configuration wherein the finger modules 200 were in the scoop arrangement for scooping a pile of noodles. The scoop arrangement is also preferred for gripping multiple loose objects 110 such as peanuts, as opposed to picking them up individually such as with the pinch or claw arrangement.

As shown in FIG. 8B, the robotic gripper 100 adopted a grip configuration wherein the finger modules 200 were in the claw arrangement for picking a floret of broccoli. Similarly, as shown in FIG. 8C, the finger modules 200 were in the claw arrangement for picking a tangerine. For small objects 110 such as those with diameters smaller than 20 mm, like a raspberry as shown in FIG. 8D, the finger modules 200 were in the claw arrangement, but the first finger module 200a (thumb) was an inward thumb wherein the thumb had moved 20 mm inward from its home position to reduce the gripping width. The adjustable finger modules 200 are evidently advantageous in handling objects 110 with various dimensions without replacing entire finger modules 200.

As shown in FIG. 8E, the robotic gripper 100 adopted a grip configuration wherein the finger modules 200 were in the pinch arrangement for picking long objects 110, such as a sausage, oyster mushroom, or long bean (as shown in FIG. 8E), because long objects 110 cannot be manipulated steadily with the claw arrangement. The pinch arrangement can also be used to manipulate fragile objects 110 such as pudding and uncooked tofu (as shown in FIG. 8F).

The robotic gripper 100 can be attached to a delta robot 310, such as the ABB IRB 360 FlexPicker, cooperative with a vision system 400 with object detection for high-speed packaging of objects 110. A packaging process was performed to pick and place food items 110 of various shapes and sizes using two different grip configurations—clawing and pinching—and under high speed.

As shown in FIG. 8G, the food items 110 included potatoes, omelettes, broccoli, and sausages, and were delivered by a first conveyor system 312. Due to the food preparation process, non-uniformity in the shapes and sizes of the food items 110 were observed. The suitable grip configuration would depend on the physical characteristics of the food items 110 that the robotic gripper 100 needs to interact with, as well as depend on the arrangement and orientation of the food items 110 on the first conveyor system 312. For example, a potato piece could be stably gripped by clawing, while longitudinally shaped food items such as sausages are more stably gripped by pinching.

Five food items 110 were picked by the robotic gripper 100 and placed into each food container 314. The food containers 314 may be delivered by a second conveyor system 316. These food items 110 included two potatoes, one omelette, one broccoli, and one sausage, which are common for in-flight meals. The robotic gripper 100 was able to steadily pack the food items 110 into the food container 314 in about 15 seconds. As the material of the finger actuators 220 (e.g. NinjaFlex filament) increased the stiffness compared to existing soft grippers and the food-safe sleeve 228 restrained over-bending, the robotic gripper 100 was able to grip the food items 110 at high speed while maintaining the stability of the gripping.

Vision System

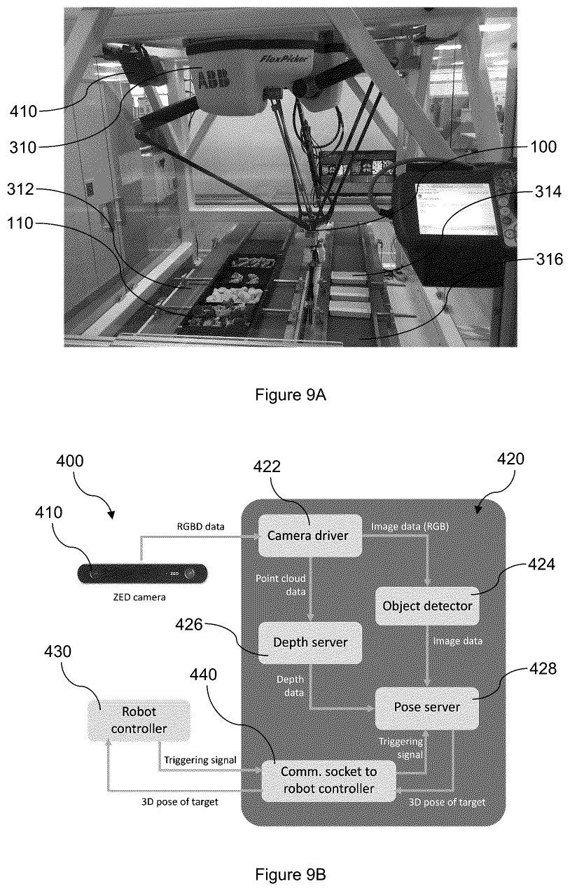

As described above and with reference to FIGS. 9A and 9B, the robotic gripper 100 is cooperative with the delta robot 310 and vision system 400 for picking and placing of multiple food items 110 on delivered by the first conveyor system 312. The vision system 400 was developed to recognize food items 110 and the orientation of each food item 110, although it will be appreciated that the vision system 400 can be modified to recognize other objects 110. The vision system 400 includes an imaging device 410 for capturing visual data of the food items 110 and a vision processing module 420 for processing the visual data. The imaging device 410 may be a ZED stereo camera.

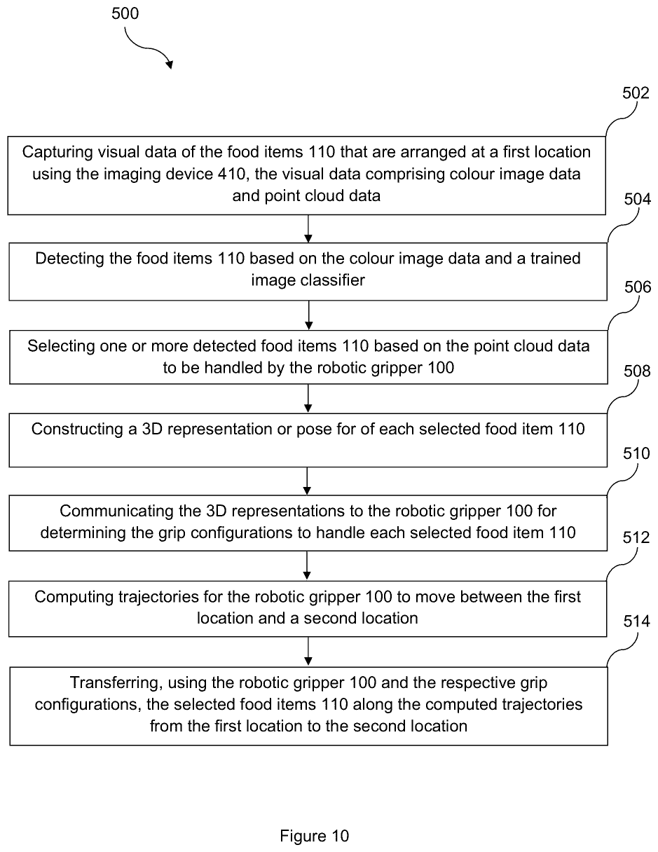

Further with reference to FIG. 10, there is a method 500 for handling objects or food items 110 with the robotic gripper 100. The vision system 400 includes a processor for performing various steps of the method 500. For example, the processor cooperates with various modules/components of the vision system 400, such as the imaging device 410 and vision processing module 420.

The method 500 includes a step 502 of capturing visual data of the food items 110 that are arranged at a first location using the imaging device 410. The first location may refer to the first conveyor system 312 that supplies the food items 110. The visual data includes colour image data and point cloud data of the food items 110. The vision processing module 420 includes an imaging module 422 for calibrating and controlling the imaging device 410 and providing the visual data including the stream of colour image data and point cloud data. The colour image data includes RGB (red green blue) data of the food items 110, and the point cloud data includes coordinate data, particularly height or depth, of the food items 110. The point cloud data may have an accuracy of ±2.5 mm at a distance of 1 m.

The method 500 includes a step 504 of detecting the food items 110 based on the colour image data and a trained image classifier. The vision processing module 420 includes an objection detection module 424 for detecting, recognizing, and classifying the food items 110. In computer vision, the objective of detection is to notice or discover the presence of a food item 110 within a field of view of the imaging device 410, specifically within an image or video frame captured by the imaging device 410. Object recognition is a process for identifying or knowing the nature of a food item 110 in an image or video frame. Recognition can be based on matching, learning, or pattern recognition algorithms with the objective being to classify the food item 110.

Various algorithms can be used in the objection detection module 424 to detect, recognize, and classify the food items 110. The image classifier can be trained with machine learning algorithms and training data to improve object recognition. In many embodiments, the YOLOv3 algorithm is used because of its fast detection speed and high accuracy. A dataset of food items 110 was built to train the image classifier and a pre-trained weight file was used as a CNN feature extractor on the dataset. The dataset has 5 categories with 6110 images for training and validation and 346 images for testing. Each food item 110 was annotated with a bounding box with the class, range of orientation, centre point, and the size of the box. A training period of at least 56 hours to reach 56,000 iterations in the dataset was completed. After training the image classifier successfully, the final weight file was used in the objection detection module 424 to receive the colour image data stream and execute the YOLOv3 algorithm. The objection detection module 424 outputs the range of orientation and bounding boxes for the detected food items 110 on the first conveyor system 312.

The method 500 includes a step 506 of selecting one or more detected food items 110 based on the point cloud data to be handled by the robotic gripper 100. The vision processing module 420 includes a depth module 426 for determining depth information of the food items 110 from the point cloud data. Specifically, the depth information (z values) is determined relative to the xy-plane which is parallel to the first conveyor system 312 where the food items 110 are being delivered. The z-values were used to determine the selection of food items 110 due to the structural characteristics of pile, since selecting the top food item 110 in the pile would have the lowest risk of damage to the other food items 110.

The method 500 includes a step 508 of constructing a 3D representation or pose of each selected food item 110. The vision processing module 420 includes an object construction module 428 for determining the 3D representation of the selected food item 110 based on information from the object detection module 424 and depth module 426. The method 500 includes a step 510 of communicating the 3D representations to the robotic gripper 100 for determining the grip configurations to handle each selected food item 110. Specifically, the object construction module 428 constructs the 3D representations of the selected food items 110 to be picked and sends this information to a robot controller 430 and the robotic gripper controller 130. The robot controller 430 positions the delta robot 310 to the correct orientation and moves the delta robot 310 to the respective food item 110 to be picked. The robotic gripper controller 130 adjusts the grip configuration of the robotic gripper 100 to the suitable grip configuration to handle the food item 110. Particularly, the highest-placed food items 110 would be of the highest interest and were selected to determine the suitable grip configuration.

The method 500 includes a step 512 of computing trajectories for the robotic gripper 100 to move between the first location and a second location. In some embodiments, the second location is a stationary location having fixed coordinates. In some embodiments, the second location is moving. For example, the moving second location refers to the second conveyor system 316 or more specifically to the food containers 314 being delivered by the second conveyor system 316. The method 500 may further include receiving positional and speed data of the second location and locating the second location based on positional and/or speed data of the second location, wherein the trajectories are computed based on the located second location.

The vision system 420 communicates information on the selected food items 110 and the associated grip configurations and trajectories to the control module 130 of the robotic gripper 100 and robot controller 430 of the delta robot 310 via a communication interface 440. The method 500 includes a step 514 of transferring, using the robotic gripper 100 and the respective grip configurations, the selected food items 110 along the computed trajectories from the first location to the second location.

In the packaging process performed by the method 500, during the picking operation, the robotic gripper 100 managed the picking sequence and moved to the selected food item 110 with the associated grip configuration and trajectory determined by the vision system 420. For the placing operation, the food items 110 were placed in a sequence of food containers 314 in a certain order. This task of picking different food items 110 from the conveyor system 312 and placing them in the food containers 314 requires the robotic gripper 100 to move between the conveyor system 312 and food containers 314 repeatedly in an efficient motion trajectory. Hence, an adaptive pick-and-place motion strategy was adopted to reduce the interaction duration between vision processing and motion processing.

Specifically, the selection of food items 110 and transferring of food items 110 are processed concurrently in a multithreaded computer process. For example, the multithreaded computer process is a dual thread process that is executed to allow independent processing of vision and motion. They communicate with each other when the robotic gripper 100 placed the food item 110 in the respective food container 314 such that the robotic gripper 100 would not block the field of view of the imaging device 410. In this way, the vision processing can share a common period with the motion processing to speed up the pick-and-place operations.

In computer architecture, multithreading is the ability of a processor to provide multiple threads of execution concurrently. Multithreading allows multiple threads to share one process's resources and are able to execute independently. Different functions can thus be performed by respective threads at the same time, resulting in quicker overall processing and better efficiency. In the packaging process, the robotic gripper 100 can continuously transfer the food items 110 at the same time while the vision system 400 is detecting and selecting the food items 110. The robotic gripper 100 does not need to pause for the vision system 400 to select one food item 110 before beginning to transfer the selected food item 110.

The results of the packaging process showed that the accuracy of object classification achieved a mean average precision (mAP) of about 67.06%, and the average duration for each inference circle from object classification to determining the grip configuration was about 92.7 ms. Moreover, the food items 110 in the top layer were all successfully detected and classified according to food type. The food selection and their orientations were also produced along with the detection. As such, the vision system 400 and method 500 can be used together with the robotic gripper 100 and delta robot 310, and similarly with other robotic systems, for real-time automated food handling and packaging.

The vision system 400 and method 500 may be enhanced by incorporating finite element methods (FEM). Specifically, an FEM model may be built for various objects 110 so improve determination of the best grip configuration to efficiently handle objects 110 with irregular shapes and sizes. The vision system 400 and method 500 may also be enhanced by incorporating object detection at the second location. This object detection can verify whether objects 110 have been successfully transferred to the second location. If an object 110 is not transferred successfully, the robotic gripper 100 may be configured to reattempt this task and transfer the same object 110 to the second location.

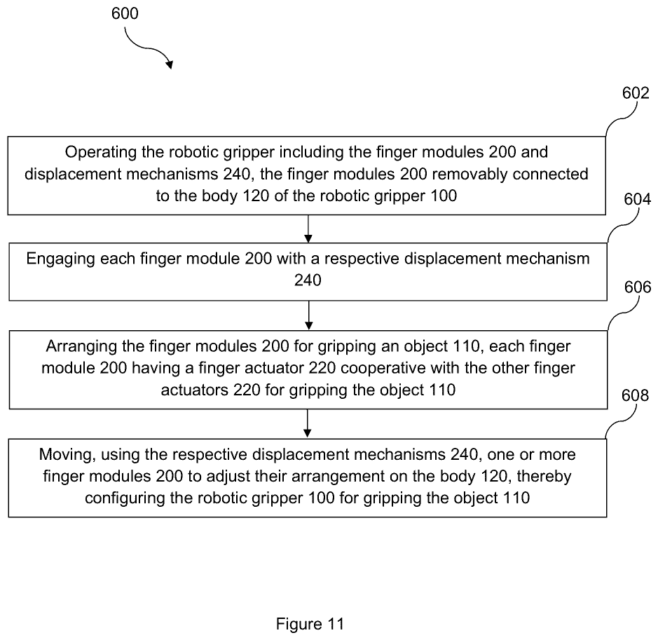

In many embodiments with reference to FIG. 11, there is a method 600 for adjusting the robotic gripper 100. The method 600 includes a step 602 of operating the robotic gripper including the finger modules 200 and displacement mechanisms 240, the finger modules 200 removably connected to the body 120 of the robotic gripper 100. The method 600 includes a step 604 of engaging each finger module 200 with a respective displacement mechanism 240. The method 600 includes a step 606 of arranging the finger modules 200 for gripping an object 110, each finger module 200 having a finger actuator 220 cooperative with the other finger actuators 220 for gripping the object 110. The method 600 includes a step 608 of moving, using the respective displacement mechanisms 240, one or more finger modules 200 to adjust their arrangement on the body 120, thereby configuring the robotic gripper 100 for gripping the object 110. Moving of the finger modules 200 may include linear and/or rotational displacement of the respective finger module 200 with respect to the body 120.

Therefore, the robotic gripper 100 can be used in various applications for handling various objects 110 by reconfiguring the finger modules 200 and the grip configurations. Each of the finger modules 200 is replaceable and its position is adjustable, enable the robotic gripper 100 to adapt itself more readily to diverse range of objects 110. This reduces costs to use different grippers for different objects, and reduces the time and labour required to provide suitable gripping configurations based on the type of objects 110. The robotic gripper 100 would be better suited to handle objects 110 in complex gripping scenarios and to pick up objects 110 more efficiently and accurately. The gripping configuration can be adjusted based on the shape and size of objects 110, therefore making the robotic gripper 100 a one-size-fits-all gripper for processing and packaging line in many applications and industries, such as food manufacturing which may require food assembly automation. Packaging tasks have been conducted successfully for handling food items 110 in in-flight meals using the robotic gripper 100 with the vision system 400. These tasks were completed successfully under high-speed, making the robotic gripper 100 and vision system 400 a suitable solution for food and grocery supply chains.

Rotatable Joint Mechanism

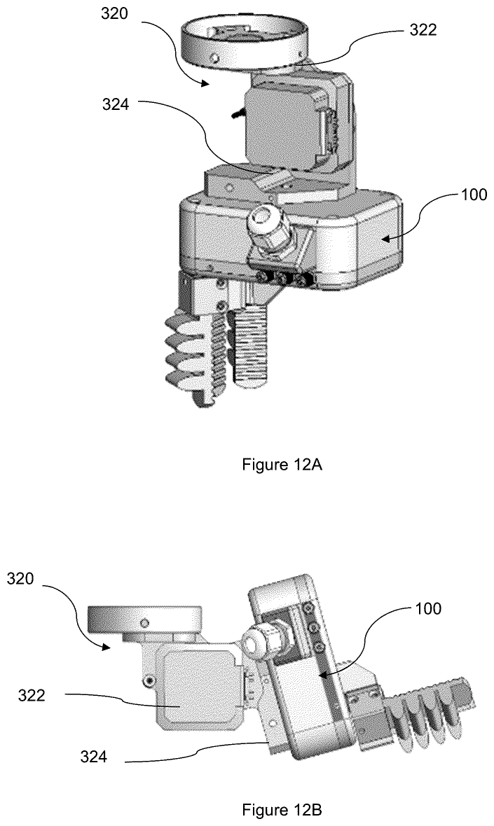

In some embodiments as shown in FIGS. 12A and 12B, there is a rotatable joint mechanism 320 configured for coupling the robotic gripper 100 to a robotic arm, such as the robotic arm 300 or a robotic arm of the delta robot 310. The rotatable joint mechanism 320 may be part of the robotic gripper 100 and/or may be connected to the body 120 of the robotic gripper 100. As some robotic arms do not have a bending joint at the wrist region (with the robotic gripper 100 resembling a hand), the rotatable joint mechanism 320 can provide additional degrees of freedom to the robotic gripper 100 to facilitate scoop/hook motion. This motion is useful to perform scooping of food items 110 such as but not limited to noodles, rice, etc. The rotatable joint mechanism 320 includes a stepper motor 322 and linkage structures 324. The stepper motor can be programmed to control the degrees of rotation and a software user interface may be provided to allow the user to modify the rotation angles.

Finger Actuator with Resilient Element

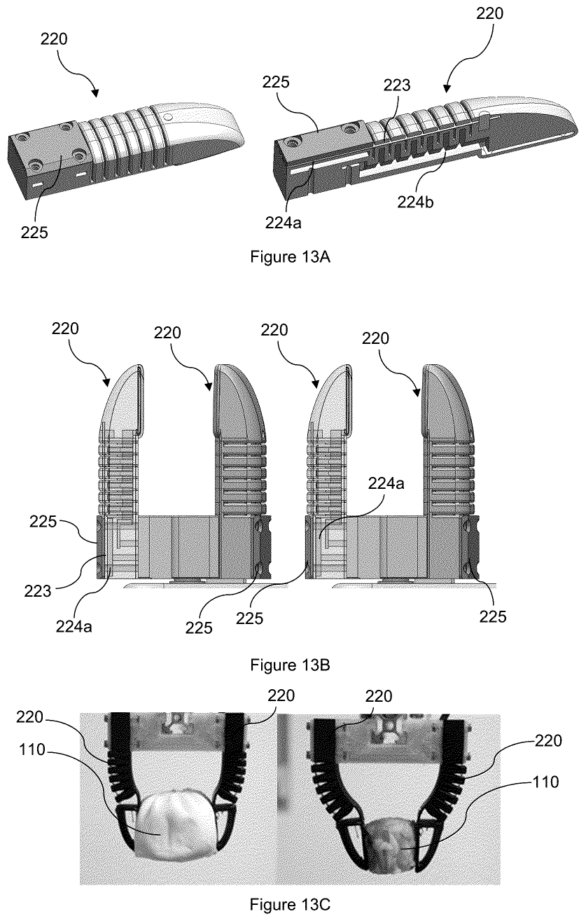

In many embodiments, each finger actuator 220 may be fabricated by additive manufacturing or 3D printing. In some embodiments as shown in FIGS. 13A and 13B, the finger actuator 220 is bendable and includes a resilient element 223 for stiffening the finger actuator 220, and a cover plate 225. The resilient element 223 may be in the form of an elongated strip made of a metallic material such as spring steel and may have a thickness of 0.1 mm. The finger actuator 220 further includes the fluidic channel 224 divided into a proximal portion 224a and a distal portion 224b arranged at corresponding proximal and distal sections of the finger actuator 220. The distal fluidic channel portion 224b is inflatable for bending the bendable finger actuator 220, and the proximal fluidic channel portion 224a is configured for locking the resilient element 223. More specifically, the proximal fluidic channel portion 224a is inflatable to block and prevent the resilient element 223 from moving backward upon inflation. This will lock the bending profile of the finger actuator 220 in place. The bending profile of the finger actuator 220 can be locked, and this feature is crucial for gripping objects 110 in a tightly cluttered environment.

As shown in FIG. 13B, the resilient element 223 is disposed between the cover plate 225 and the proximal fluidic channel portion 224a. The resilient element 223 is free to move in the space between the cover plate 225 and the proximal fluidic channel portion 224a when the proximal fluidic channel portion 224a is not inflated. Upon inflation, the inflated proximal fluidic channel portion 224a will press the resilient element 223 against the cover plate 225 and increase the rigidity of the finger actuator 220. When the finger actuator 220 is actuated (i.e. by communicating air to the distal fluidic channel portion 224b), the resilient element 223 will move together with the flexed finger actuator 220, the resilient element 223 moving towards the distal section of the finger actuator 220. When the proximal fluidic channel portion 224a is inflated, the inflated proximal fluidic channel portion 224a will fully block the space formed with the cover plate 225. In this scenario, the inflated proximal fluidic channel portion 224a prevents returning of the resilient element 223, i.e. the resilient element 223 will not be able to move back, and the bending profile of the bent finger actuator 220 will be locked. The resilient element 223 is thus able to stiffen the bent finger actuator 220 and to lock the bending profile of the finger actuator 220.

By locking the bending profile, the finger actuator 220 can cooperate with one or more other finger actuators 220, similarly with bending profiles locked by the respective resilient elements 223, to more securely grip an object 110. For example as shown in FIG. 13C, the resilient elements 223 can be controlled to bend the finger actuators 220 such that the contact area of each finger actuator 220 with the object 110 is substantially straight. This increases the total contact area between the substantially straight sides of the finger actuators 220 and the object 110, enabling the finger actuators 220 to achieve parallel gripping. The robotic gripper 100 with this parallel grip configuration can grip objects 110 having straight sides, such as cylindrical ones, with better gripping stability and performance.

Different finger actuators 220 of the robotic gripper 100 may be configured with different bending profiles. A finger actuator 220 may have a different series of bellow-shaped sections 222, such as varying in number and/or size, than another finger actuator 220. For example, by removing the bellow-shaped section 222 at the distal section of the finger actuator 220, the finger actuator 220 can still bend to a certain extent but will not be able to achieve the parallel bending profile mentioned above. The resilient element 223 can help to stiffen the finger actuator 220 and achieve the parallel bending profile. It will be appreciated that more bellow-shaped sections 222 may be removed to achieve different bending profiles with the help of the resilient element 223 to stiffen the finger actuator 220. The different bellow-shaped sections 222 thus enable the finger actuator 220 to bend to a different bending profile upon inflation. Additionally, the resilient element 223 stiffens the bent finger actuator 220 and locks it in its unique bending profile. Different finger actuators 220 can thus achieve different bending profiles, enabling the robotic gripper 100 to achieve different grip configurations not limited to the parallel grip configuration mentioned above.

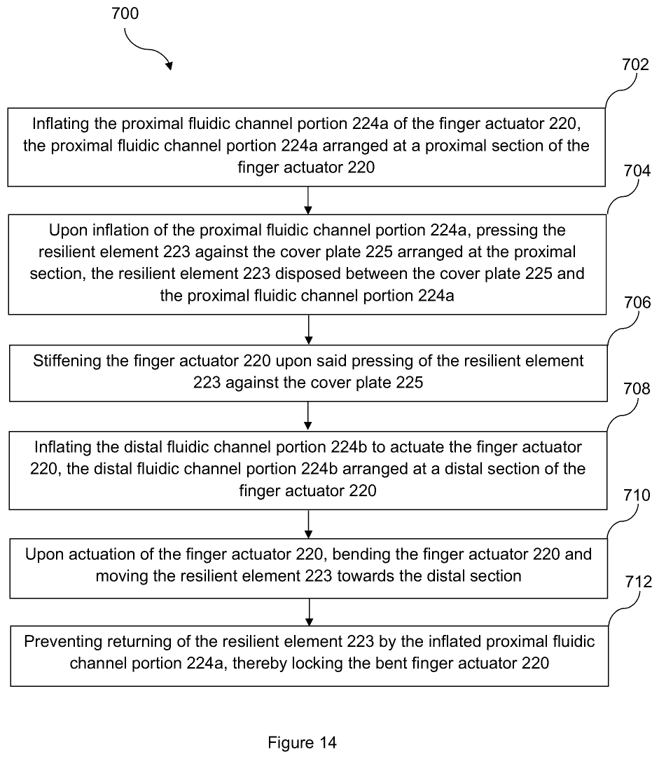

In some embodiments with reference to FIG. 14, there is a method 700 for locking the bending profile of the finger actuator 220 having the resilient element 223. The method 700 includes a step 702 of inflating the proximal fluidic channel portion 224a of the finger actuator 220, the proximal fluidic channel portion 224a arranged at a proximal section of the bendable finger actuator 220. The method 700 includes a step 704 of, upon inflation of the proximal fluidic channel portion 224a, pressing the resilient element 223 against the cover plate 225 arranged at the proximal section, the resilient element 223 disposed between the cover plate 225 and the proximal fluidic channel portion 224a. The method 700 includes a step 706 of stiffening the finger actuator 220 upon said pressing of the resilient element 223 against the cover plate 225. The method 700 includes a step 708 of inflating the distal fluidic channel portion 224b to actuate the finger actuator 220, the distal fluidic channel portion 224b arranged at a distal section of the finger actuator 220. The method 700 includes a step 710 of, upon actuation of the finger actuator 220, bending the finger actuator 220 and moving the resilient element 223 towards the distal section. The method 700 includes a step 712 of preventing returning of the resilient element 223 by the inflated proximal fluidic channel portion 224a, thereby locking the bent finger actuator 220.

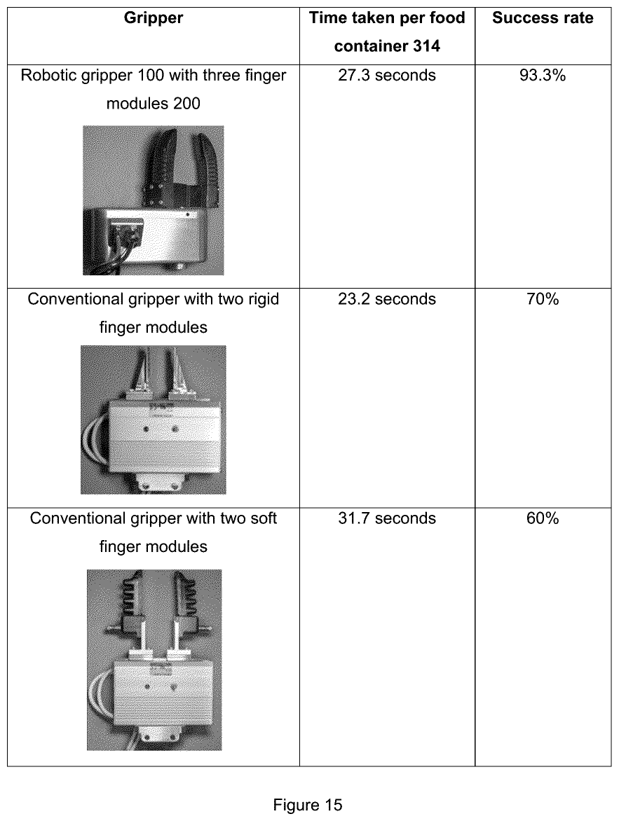

Tests have been performed to compare the performance of the robotic gripper 100 having three finger modules (including the finger actuators 220 with the resilient elements 223) against a conventional gripper with two rigid finger modules and a conventional gripper with two soft finger modules. The conventional grippers were only able to pinch objects 110 while the robotic gripper 100 can pinch and claw objects 110. The tests involved picking and placing five food items 110 into food containers 314. The performance results are shown in FIG. 15. The robotic gripper 100 averaged 27.3 seconds for the time taken per food container 314 while the conventional rigid and soft grippers averaged 23.2 and 31.7 seconds, respectively. The robotic gripper 100 achieved a success rate of 93.3% while the conventional rigid and soft grippers achieved 70% and 60%, respectively. The robotic gripper 100 is evidently more accurate and effective in handling objects 110.

Additive Manufacturing

The robotic gripper 100 and parts thereof, including the finger modules 200 and finger actuators 220, can be fabricated by various manufacturing methods. In some embodiments, the robotic gripper 100 or parts thereof or a product comprising the robotic gripper 100 or parts thereof may be formed by a manufacturing process that includes an additive manufacturing process. A common example of additive manufacturing is three-dimensional (3D) printing; however, other methods of additive manufacturing are available. Rapid prototyping or rapid manufacturing are also terms which may be used to describe additive manufacturing processes.

As used herein, “additive manufacturing” refers generally to manufacturing processes wherein successive layers of material(s) are provided on each other to “build-up” layer-by-layer or “additively fabricate”, a 3D component. This is compared to some subtractive manufacturing methods (such as milling or drilling), wherein material is successively removed to fabricate the part. The successive layers generally fuse together to form a monolithic component which may have a variety of integral sub-components. In particular, the manufacturing process may allow an example of the disclosure to be integrally formed and include a variety of features not possible when using prior manufacturing methods.

Additive manufacturing methods described herein enable manufacture to any suitable size and shape with various features which may not have been possible using prior manufacturing methods. Additive manufacturing can create complex geometries without the use of any sort of tools, moulds, or fixtures, and with little or no waste material. Instead of machining components from solid billets of plastic or metal, much of which is cut away and discarded, the only material used in additive manufacturing is what is required to shape the part.

Suitable additive manufacturing techniques in accordance with the present disclosure include, for example, Fused Deposition Modelling (FDM), Selective Laser Sintering (SLS), 3D printing such as by inkjets and laserjets, Stereolithography (SLA), Direct Selective Laser Sintering (DSLS), Electron Beam Sintering (EBS), Electron Beam Melting (EBM), Laser Engineered Net Shaping (LENS), Electron Beam Additive Manufacturing (EBAM), Laser Net Shape Manufacturing (LNS), Direct Metal Deposition (DMD), Digital Light Processing (DLP), Continuous Digital Light Processing (CDLP), Direct Selective Laser Melting (DSLM), Selective Laser Melting (SLM), Direct Metal Laser Melting (DMLM), Direct Metal Laser Sintering (DMLS), Material Jetting (MJ), NanoParticle Jetting (NPJ), Drop On Demand (DOD), Binder Jetting (BJ), Multi Jet Fusion (MJF), Laminated Object Manufacturing (LOM), and other known processes.

The additive manufacturing processes described herein may be used for forming components using any suitable material. For example, the material may be metal, plastic, polymer, composite, or any other suitable material that may be in solid, liquid, powder, sheet material, wire, or any other suitable form or combinations thereof. More specifically, according to exemplary embodiments of the present disclosure, the additively manufactured components described herein may be formed in part, in whole, or in some combination of materials suitable for use in additive manufacturing processes and which may be suitable for the fabrication of examples described herein.

As noted above, the additive manufacturing process disclosed herein allows a single component to be formed from multiple materials. Thus, the examples described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

Additive manufacturing processes typically fabricate components based on 3D information, for example a 3D computer model (or design file), of the component. Accordingly, examples described herein not only include products or components as described herein, but also methods of manufacturing such products or components via additive manufacturing and computer software, firmware or hardware for controlling the manufacture of such products via additive manufacturing.

The structure of the product may be represented digitally in the form of a design file. A design file, or computer aided design (CAD) file, is a configuration file that encodes one or more of the surface or volumetric configuration of the shape of the product. That is, a design file represents the geometrical arrangement or shape of the product.

Design files can take any now known or later developed file format. For example, design files may be in the Stereolithography or “Standard Tessellation Language” (.stl) format which was created for Stereolithography CAD programs of 3D Systems, or the Additive Manufacturing File (.amf) format, which is an American Society of Mechanical Engineers (ASME) standard that is an extensible markup-language (XML) based format designed to allow any CAD software to describe the shape and composition of any 3D object to be fabricated on any additive manufacturing printer. Further examples of design file formats include AutoCAD (.dwg) files, Blender (.blend) files, Parasolid (.x_t) files, 3D Manufacturing Format (0.3mf) files, Autodesk (3ds) files, Collada (.dae) files and Wavefront (.obj) files, although many other file formats exist.

Design files can be produced using modelling (e.g. CAD modelling) software and/or through scanning the surface of a product to measure the surface configuration of the product. Once obtained, a design file may be converted into a set of computer executable instructions that, once executed by a processer, cause the processor to control an additive manufacturing apparatus to produce a product according to the geometrical arrangement specified in the design file. The conversion may convert the design file into slices or layers that are to be formed sequentially by the additive manufacturing apparatus. The instructions (otherwise known as geometric code or “G-code”) may be calibrated to the specific additive manufacturing apparatus and may specify the precise location and amount of material that is to be formed at each stage in the manufacturing process. As discussed above, the formation may be through deposition, through sintering, or through any other form of additive manufacturing method.

The code or instructions may be translated between different formats, converted into a set of data signals and transmitted, received as a set of data signals and converted to code, stored, etc., as necessary. The instructions may be an input to the additive manufacturing system and may come from a part designer, an intellectual property (IP) provider, a design company, the operator or owner of the additive manufacturing system, or from other sources. An additive manufacturing system may execute the instructions to fabricate the product using any of the technologies or methods disclosed herein.

Design files or computer executable instructions may be stored in a (transitory or non-transitory) computer readable storage medium (e.g., memory, storage system, etc.) storing code, or computer readable instructions, representative of the product to be produced. As noted, the code or computer readable instructions defining the product that can be used to physically generate the object, upon execution of the code or instructions by an additive manufacturing system. For example, the instructions may include a precisely defined 3D model of the product and can be generated from any of a large variety of well-known CAD software systems such as AutoCAD®, TurboCAD®, DesignCAD 3D Max, etc. Alternatively, a model or prototype of the product may be scanned to determine the 3D information of the product. Accordingly, by controlling an additive manufacturing apparatus according to the computer executable instructions, the additive manufacturing apparatus can be instructed to print out the product.

In light of the above, embodiments include methods of manufacture via additive manufacturing. This includes the steps of obtaining a design file representing the product and instructing an additive manufacturing apparatus to manufacture the product according to the design file. The additive manufacturing apparatus may include a processor that is configured to automatically convert the design file into computer executable instructions for controlling the manufacture of the product. In these embodiments, the design file itself can automatically cause the production of the product once input into the additive manufacturing apparatus. Accordingly, in this embodiment, the design file itself may be considered computer executable instructions that cause the additive manufacturing apparatus to manufacture the product. Alternatively, the design file may be converted into instructions by an external computing system, with the resulting computer executable instructions being provided to the additive manufacturing apparatus.

Given the above, the design and manufacture of implementations of the subject matter and the operations described in this specification can be realized using digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or other manufacturing technology.

In the foregoing detailed description, embodiments of the present disclosure in relation to the robotic gripper are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A robotic gripper comprising:
a body;
a plurality of displacement mechanisms;
a plurality of finger modules removably connected or connectable to the body, such that each finger module engages with a respective displacement mechanism;
each finger module comprising a finger actuator cooperative with the other finger actuators for gripping an object; and
each displacement mechanism is configured for moving the respective finger module to adjust its arrangement on the body, thereby configuring the robotic gripper for gripping the object.

2. The robotic gripper according to claim 1, wherein each displacement mechanism is configured for linear and/or rotational displacement of the respective finger module with respect to the body.

3. The robotic gripper according to claim 1, wherein each finger actuator comprises:
a resilient element configured for stiffening the finger actuator; and
a cover plate and an inflatable channel arranged at a proximal section of the finger actuator, the resilient element disposed between the cover plate and inflatable channel,
wherein upon inflation of the channel, the inflated channel presses the resilient element against the cover plate, thereby stiffening the finger actuator; and
wherein upon actuation and bending of the finger actuator, the resilient element moves towards a distal section of the finger actuator, the inflated channel preventing returning of the resilient element, thereby locking the bent finger actuator.

4. The robotic gripper according to claim 1, wherein each finger actuator comprises:
a number of smaller-width bellow-shaped sections at a proximal section of the finger actuator; and
a number of larger-width bellow-shaped sections at a distal section of the finger actuator.

5. The robotic gripper according to claim 1, wherein each finger module comprises a sleeve for wearing over the finger actuator.

6. The robotic gripper according to claim 1, wherein each finger module comprises a tactile sensor.

7. The robotic gripper according to claim 6, wherein the tactile sensors are configured for providing feedback to control a grip configuration of the robotic gripper for gripping the objects.

8. The robotic gripper according to claim 7, wherein the grip configuration is controlled based on intensity of fluctuations in variance and covariance trends determined by the tactile sensors.

9. The robotic gripper according to claim 1, wherein the robotic gripper is cooperative with a vision system for detection of the objects.

10. A method for configuring a robotic gripper, the method comprising:
operating the robotic gripper comprising a plurality of finger modules and a plurality of displacement mechanisms, the finger modules removably connected to a body of the robotic gripper;
engaging each finger module with a respective displacement mechanism;
arranging the finger modules for gripping an object, each finger module comprising a finger actuator cooperative with the other finger actuators for gripping the object; and
moving, using the respective displacement mechanisms, one or more finger modules to adjust their arrangement on the body, thereby configuring the robotic gripper for gripping the object.

11. The method according to claim 10, wherein moving of the finger modules comprises linear and/or rotational displacement of the respective finger module with respect to the body.

12. A computer program comprising computer executable instructions that, when executed by a processor, cause the processor to control an additive manufacturing apparatus to manufacture a product comprising the robotic gripper according to claim 1.

13. A method of manufacturing a product via additive manufacturing, the method comprising:
obtaining an electronic file representing a geometry of the product wherein the product comprises the robotic gripper according to claim 1; and
controlling an additive manufacturing apparatus to manufacture, over one or more additive manufacturing steps, the product according to the geometry specified in the electronic file.

14. A method for handling objects with a robotic gripper, the method comprising:
capturing visual data of the objects arranged at a first location using an imaging device, the visual data comprising colour image data and point cloud data;
detecting the objects based on the colour image data and a trained image classifier;
selecting one or more detected objects based on the point cloud data to be handled by the robotic gripper;
constructing a 3D representation for each selected object;
communicating the 3D representations to the robotic gripper for determining grip configurations to handle each selected object;
computing trajectories for the robotic gripper to move between the first location and a second location;
transferring, using the robotic gripper and the respective grip configurations, the selected objects along the computed trajectories from the first location to the second location,
wherein the selection of objects and transferring of objects are processed concurrently in a multithreaded computer process.

15. The method according to claim 14, further comprising:
receiving positional and speed data of the second location; and
locating the second location based on positional and/or speed data of the second location,
wherein the trajectories are computed based on the located second location.

16. A finger actuator comprising:
a resilient element for stiffening the finger actuator; and
a cover plate and an inflatable channel arranged at a proximal section of the finger actuator, the resilient element disposed between the cover plate and inflatable channel,
wherein upon inflation of the channel, the inflated channel presses the resilient element against the cover plate, thereby stiffening the finger actuator; and
wherein upon actuation and bending of the finger actuator, the resilient element moves towards a distal section of the finger actuator, the inflated channel preventing returning of the resilient element, thereby locking the bent finger actuator.

17. The finger actuator according to claim 16, wherein each finger actuator comprises:
a number of smaller-width bellow-shaped sections at a proximal section of the finger actuator; and
a number of larger-width bellow-shaped sections at a distal section of the finger actuator.

18. A computer program comprising computer executable instructions that, when executed by a processor, cause the processor to control an additive manufacturing apparatus to manufacture a product comprising the finger actuator according to claim 16.

19. A method of manufacturing a product via additive manufacturing, the method comprising:
obtaining an electronic file representing a geometry of the product wherein the product comprises the finger actuator according to claim 16; and
controlling an additive manufacturing apparatus to manufacture, over one or more additive manufacturing steps, the product according to the geometry specified in the electronic file.

20. A method for locking a bending profile of a finger actuator, the method comprising:
inflating a proximal portion of a fluidic channel of the finger actuator, the proximal fluidic channel portion arranged at a proximal section of the finger actuator;
upon inflation of the proximal fluidic channel portion, pressing a resilient element against a cover plate arranged at the proximal section, the resilient element disposed between the cover plate and the proximal fluidic channel portion;
stiffening the finger actuator upon said pressing of the resilient element against the cover plate;
inflating a distal portion of the fluidic channel to actuate the finger actuator, the distal fluidic channel portion arranged at a distal section of the finger actuator;
upon actuation of the finger actuator, bending the finger actuator and moving the resilient element towards the distal section; and
preventing returning of the resilient element by the inflated proximal fluidic channel portion, thereby locking the bent finger actuator.
